(19) United States
(12) Patent Application Publication
(10) Pub. No.: US 2018/0264731 A1
(43) Pub. Date: Sep. 20, 2018

(54) SYSTEM AND METHOD FOR DELIVERING INK INTO A 3D PRINTING APPARATUS

(71) Applicant: XJET LTD., Rehovot (IL)

(72) Inventors: Eliahu Kritchman, Tel Aviv (IL); Hanan GOTHAIT, Rehovot (IL); Timofey SHMAL, Rehovot (IL); Shlomo YITZHAIK, Ness Ziona (IL)

(73) Assignee: XJET LTD., Rehovot (IL)

(21) Appl. No.: 15/921,279

(22) Filed: Mar. 14, 2018

Related U.S. Application Data
(60) Provisional application No. 62/471,417, filed on Mar. 15, 2017.

(51) Int. Cl. B29C 64/357; B29C 64/106; B29C 64/35; B33Y 30/00; B33Y 40/00; B29C 64/245; B29C 64/321

(52) U.S. Cl. CPC B29C 64/357; B29C 64/106; B29C 64/35; B29C 64/321; B33Y 40/00; B29C 64/245; B33Y 30/00

(57) ABSTRACT

The present disclosure provides additive manufacturing apparatuses and maintenance methods. For example, in one embodiment an additive manufacturing apparatus is provided. The apparatus includes a reservoir configured to contain additive manufacturing material and a supply conduit for interconnecting the reservoir with a print head. The apparatus further includes a regulator configured to control pressure of additive manufacturing material in the print head to trigger purging of the print head and an air-ink separator configured to receive a mixture of air and purged additive manufacturing material. The air-ink separator is configured to reclaim at least a portion of the additive manufacturing material from the mixture. The apparatus may further include a return conduit interconnecting the air-ink separator with the reservoir for circulating back the reclaimed additive manufacturing material to the reservoir to enable the reclaimed additive manufacturing material to be utilized for manufacturing a three-dimensional object.

### CROSS REFERENCES TO RELATED APPLICATIONS

This application claims the benefit of priority of U.S. Provisional Patent Application No. 62/471,417, filed on Mar. 15, 2017, which is incorporated herein by reference.

### BACKGROUND

### Technical Field

The present disclosure relates to three-dimensional printing systems and, more particularly, to systems, devices, and methods for delivering ink into the three-dimensional printing systems.

### Background

Three-dimensional printing is a process of making an object from a digital model. The process, which is also known as an “additive manufacturing” process, includes laying down successive layers of material until the object is created. There are several different approaches of three-dimensional printing known in the industry. One promising approach of three-dimensional printing is using inkjet technology. In this approach a three-dimensional inkjet printer dispenses a customized ink with small particles of object material from print heads to construct the object layer-by-layer.

Typically, the ink used for three-dimensional printing may be heavily loaded with solid particles. The printing process requires an adjustment of a relatively big set of parameters. For example, the printing process may involve object ink and support ink that often includes a dispersion of solid particles of different materials in different particle sizes. It is a challenge to keep the solid particles separated in a carrier liquid and avoid their agglomeration, which may clog the jetting orifices and other system components. The disclosure below describes systems and methods to reclaim ink dispensed from the print head during non-printing periods to be utilized for manufacturing the three-dimensional object.

### SUMMARY

In one embodiment an additive manufacturing apparatus is provided. The additive manufacturing apparatus may include a reservoir configured to contain additive manufacturing material. The additive manufacturing apparatus further includes a supply conduit for interconnecting the reservoir with a print head for supplying the additive manufacturing material to the print head, wherein the print head has a plurality of nozzles for expelling the additive manufacturing material. The additive manufacturing apparatus further includes a regulator configured to control pressure of additive manufacturing material in the print head to trigger purging of the print head during a maintenance period. The additive manufacturing apparatus may also include an air-ink separator configured to receive a mixture of air and purged additive manufacturing material, wherein the air-ink separator is configured to reclaim at least a portion of the additive manufacturing material from the mixture. The additive manufacturing apparatus may further include a return conduit interconnecting the air-ink separator with the reservoir for circulating back the reclaimed additive manufacturing material to the reservoir to enable the reclaimed additive manufacturing material to be utilized for manufacturing a three-dimensional object.

In another embodiment, a maintenance method for an additive manufacturing apparatus is provided. The method may include the following steps: supplying additive manufacturing material from a reservoir to a print head, wherein the print head has a plurality of nozzles for expelling the additive manufacturing material; controlling pressure of additive manufacturing material in the print head to trigger purging of the print head during a maintenance period; receiving in an air-ink separator a mixture of air and purged additive manufacturing material, wherein the air-ink separator is configured to reclaim at least a portion of the additive manufacturing material from the mixture; circulating back the reclaimed additive manufacturing material to the reservoir during the maintenance period to enable the reclaimed additive manufacturing material to be utilized for manufacturing a three-dimensional object.

The foregoing general description and the following detailed description are exemplary and explanatory only and are not restrictive of the claims.

### BRIEF DESCRIPTION OF THE DRAWINGS

The accompanying drawings, which are incorporated in and constitute part of this disclosure, together with the description, illustrate and serve to explain the principles of various example embodiments.

FIG. 1A is a schematic illustration depicting an example of an additive manufacturing apparatus according to the present disclosure;

FIG. 1B is a schematic illustration depicting an example of an ink delivery system for the additive manufacturing apparatus of FIG. 1A;

FIG. 2 is a schematic illustration depicting an example of an ink filling system for the additive manufacturing apparatus of FIG. 1A;

FIG. 3A-3D are schematic illustrations depicting different embodiments of the ink delivery system of FIG. 1B;

FIG. 4 is a diagram depicting a maintenance process for a print head of the additive manufacturing apparatus of FIG. 1A;

FIGS. 5A-5B are schematic illustrations depicting the operation of a first component of the additive manufacturing apparatus of FIG. 1A used for extracting additive manufacturing material from a stream of air containing droplets of additive manufacturing material;

FIG. 6 is a flowchart showing an exemplary maintenance method for an additive manufacturing apparatus; and

FIG. 7 is a schematic illustration depicting the operation of a second component of the additive manufacturing apparatus of FIG. 1A used for preventing condensed fumes from dripping on the three-dimensional object.

### DETAILED DESCRIPTION

Reference will now be made in detail to the example embodiments implemented according to the present disclosure, the examples of which are illustrated in the accompanying drawings. Wherever convenient, the same reference numbers will be used throughout the drawings to refer to the same or like parts.

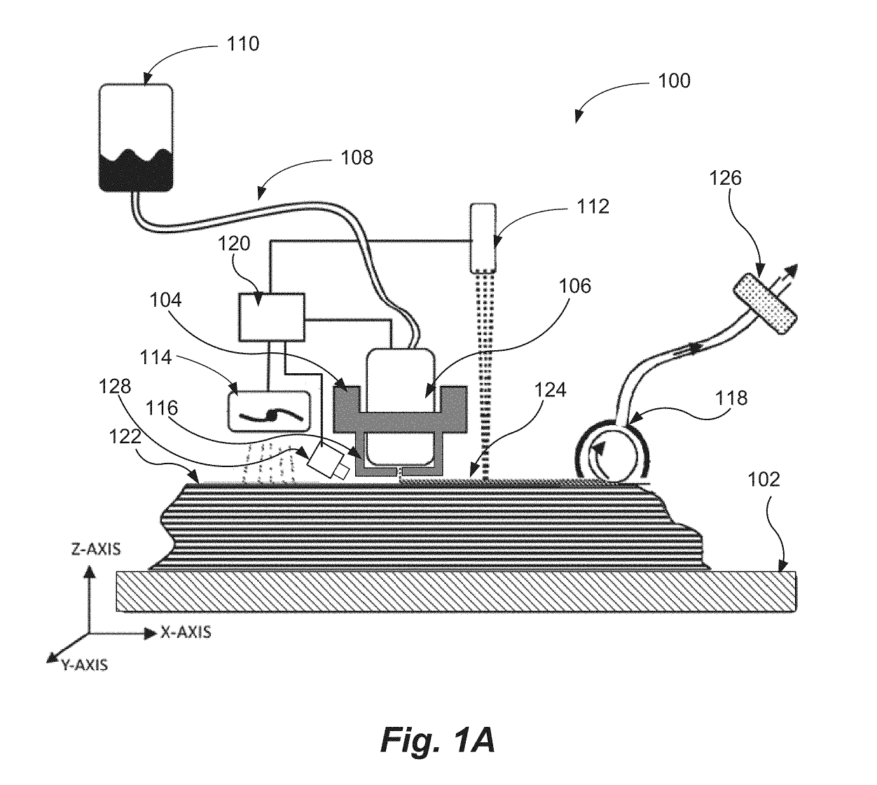

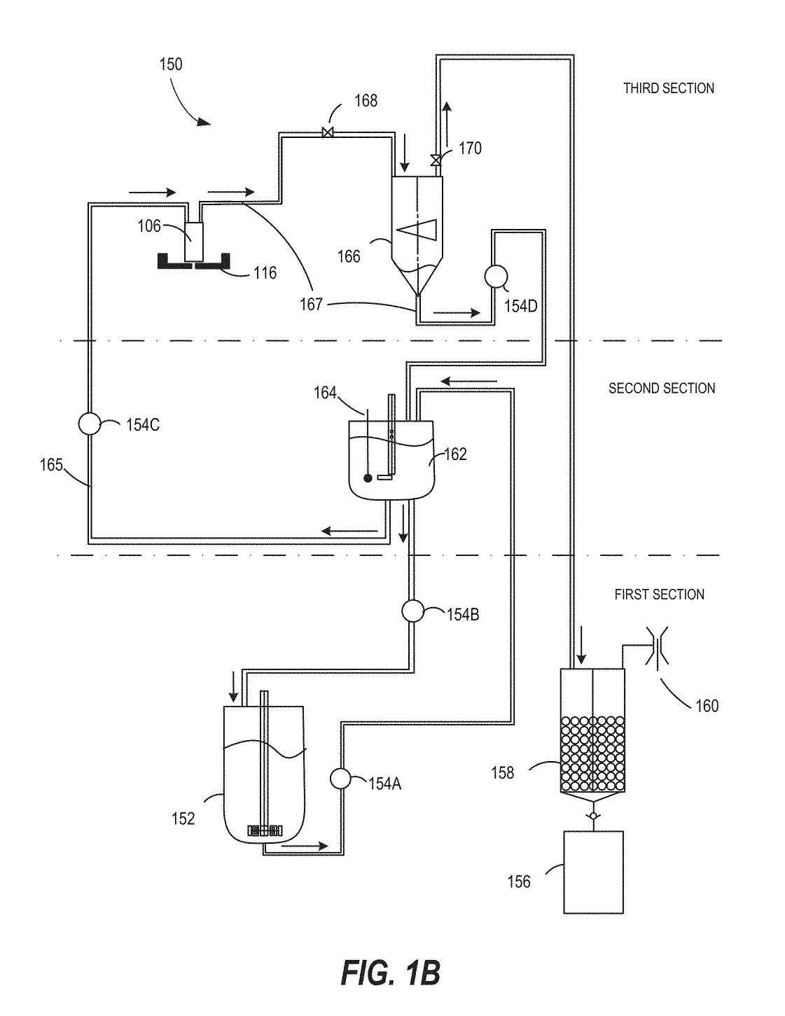

Disclosed embodiments include an additive manufacturing apparatus. As used herein, the term “additive manufacturing apparatus” broadly includes any device or system that can produce an object from a digital model by laying down successive layers of material until the object is created. FIG. 1A depicts an example of an additive manufacturing apparatus 100 in which various implementations, as described herein, may be practiced. As shown in FIG. 1A, additive manufacturing apparatus 100 may include: a printing region 102, a print head holder 104 supporting at least one print head 106, at least one conduit 108 interconnecting print head 106 with an ink reservoir 110, an energy source 112, a cooling fan 114, a shield 116, a leveling apparatus 118, and a controller 120.

Printing region 102 may be used as a base for supporting the object to be constructed in an additive manufacturing process. The term “printing region” includes an area with any rigid surface capable of holding multiple layers of material dispensed from additive manufacturing apparatus 100. The terms “printing tray” and “printing table” may also be used interchangeably in this disclosure with reference to the printing region. In one embodiment, printing region 102 may include thermally conductive material, for example, or printing region 102 may include a tray made of metal. In this embodiment, printing region 102 may be warmed to a required object temperature to assist in solidifying a recently printed layer or to accelerate the evaporation of at least part of the ink liquid components. In alternative embodiment, printing region 102 may include thermally insulating material; for example, printing region 102 may include wood, plastic, or insulating ceramics. In both embodiments, printing region 102 may keep the object's temperature and heating the recently printed layer may be accomplished by direct heat radiation from above, for example, by using energy source 112, such as a halogen lamp, IR lamp, UV lamp, a laser, flash-lamp or microwave source.

The term “printing region” should not be confused with the term “printing surface.” The term “printing surface” refers to a surface on which a new layer is to be printed. In the beginning of the printing process, printing region 102 may be the printing surface because the first layer may be printed directly on it. All the subsequent layers (e.g., the second layer), however, will be printed on top of previously deposited layers. Thus, for the second layer, the first layer is the printing surface. In the context of this disclosure and with reference to FIG. 1A, a printing surface 122 is a previously deposited layer and a new layer 124 is the layer that is currently being printed on top of printing surface 122. New layer 124 is built along the Z-direction during every printing pass and is also referred to as the upper-layer or the most-recent layer.

Consistent with embodiments of the present disclosure, additive manufacturing apparatus 100 may include print head holder 104 for maintaining at least one print head 106 spaced from printing surface 122. The term “print head holder” includes any structure suitable for holding or retaining at least one print head 106 in a fixed distance from printing surface 122 or at a changing distance from printing region 102. Because the additive manufacturing process includes laying down successive layers of material, the height of the object is gradually growing. In one embodiment, after each layer is laid down, printing region 102 shifts a little lower in the Z-direction to maintain the fixed distance between at least one print head 106 and printing surface 122. In an alternative embodiment, after each layer is laid down, print head holder 104 shifts a little higher in the Z-direction to maintain the fixed distance between at least one print head 106 and printing surface 122. In one example, the fixed distance between print head 106 and printing surface 122 may be any value between 0.5 and 5 mm. In another alternative embodiment, after each layer is laid down, printing region 102 shifts a little lower in the Z-direction and print head holder 104 shifts a little higher in the Z-direction to maintain the fixed distance between at least one print head 106 and printing surface 122. For the sake of simplicity, the following discussion will assume that print head 106 is moving while the printing tray is stationary. However, in alternative embodiments, printing tray may be configured to move underneath print head 106.

According to some embodiments, print head holder 104 may support a single print head 106 or a plurality of print heads 106. The term “print head” refers to a plurality of nozzles organized in a linear array or plate, and generally manufactured together as one. When print head 106 is connected to additive manufacturing apparatus 100, the plurality of nozzles is configured to dispense ink from ink reservoir 110 to form the object layer-by-layer. In one example, at least one print head 106 may comprise a plurality of nozzles including a first nozzle group for dispensing a first material and a second nozzle group for dispensing a second material that differs from the first material. In one embodiment, the first material may be a first type of object material and the second material may be a second type of object material. A typical case for this embodiment is when the desired object consists of two different materials. In another embodiment, the first material may be an object material used to produce the desired object and the second material may be a support material used temporarily during printing, for example, to support “negative” tilted walls of the object. Typically, print head 106 may scan new layer 124 in an X-direction substantially perpendicular to the longitudinal axis Y of new layer 124. As each object may be constructed from thousands of printed layers, typically thousands of cycles are necessary. In a case where each cycle includes multiple printings from a plurality of print heads 106, the number of cycles can be reduced from thousands to hundreds or less. Also, additive manufacturing apparatus 100 may produce multiple objects in the same run. In one embodiment, different print heads 106 may be employed for different printing materials. For example, a first print head may be used for dispensing object material and a second print head may be used for dispensing support material.

In some embodiments, additive manufacturing apparatus 100 may include at least one conduit 108 interconnecting print head 106 with an ink reservoir 110. The term “conduit” generally refers to a body having a passageway through it for the transport of a liquid or a gas. At least one conduit 108 may be flexible to enable relative movement between print head 106 and ink reservoir 110. In some embodiments, at least one conduit 108 may include a supply conduit interconnecting ink reservoir 110 with print head 106 for supplying ink to print head 106, and a return conduit (not shown) interconnecting print head 106 with ink reservoir 110 for circulating back to ink reservoir 110 at least a portion of the ink that was not expelled from print head 106. The term “ink reservoir” includes any structure configured to store ink until it is conveyed to print head 106. In some embodiments, ink reservoir 110 may include one or more tanks and an ultrasound-based element that is configured to send ultrasound or shock waves into the ink to prevent solid particles agglomeration in the ink or to break agglomerates if they already exist in the ink. In addition, additive manufacturing apparatus 100 may include a plurality of valves (not shown) operated by controller 120 and positioned along at least one conduit 108 to control the pressure in at least one print head 106, at least one conduit 108, and/or ink reservoir 110.

As mentioned above, additive manufacturing apparatus 100 may be configured to print more than one type of ink. The term “ink” includes any fluid intended for deposition on printing surface 122 in a desired pattern. The term “ink” is also known as “additive manufacturing material,” “printing material,” and “printing liquid.” These terms may be used interchangeably in this disclosure. Consistent with the present disclosure, some examples of suitable inks may include the following ingredients:
Micro and/or Nano particles—The inks described herein may include a dispersion of solid particles of any required material, e.g., metals (iron, copper, silver, gold, titanium, etc.), metal oxides, oxides (SiO2, TiO2, BiO2, etc.), metal carbides, carbides (WC, Al4C3, TiC), metal alloys (stainless steel, Titanium Ti64, etc.), inorganic salts, polymeric particles, ceramics, etc., in volatile carrier liquid. The particles may be of micro (0.5 to 10 micrometer size) and/or Nano (5 to 500 nanometer size) as required to maintain the required spatial resolution during printing, maintain the required material character (after sintering), or to satisfy limitations of a dispensing head. For example, when the dispensing print head includes nozzles of 30 μm diameter, the particles size should be equal to or smaller than 2 μm. In the context of this document, the term “object material” generally refers to solid particles used to construct the object and “support material” generally refers to solid particles used to construct support elements. The support elements are not part of the desired object and may be burned before or during the sintering process or dissolved in a liquid prior to sintering. Example for support material may include wax dissolved in an organic solvent and Sodium Chloride.
Carrier liquid—The particles may be dispersed in a carrier liquid, also referred to as a “carrier” or “solvent.” According to one embodiment, the carrier liquid may evaporate immediately after printing so that the succeeding layer is dispensed on solid material below. Therefore, the temperature of an upper-layer of the object during printing should be comparable with the boiling temperature of the carrier liquid. In another embodiment, the temperature of the upper-layer is much higher than the boiling temperature of the liquid carrier, encouraging thereby the evaporation of other organic materials like dispersants or various additives in the carrier liquid. Conventional dispersants are readily available, such as polymeric dispersants such as Disperbyk 180, Disperbyk 190, Disperbyk 163, from Byk chemie GMBH. Conventional particle ink is readily available, such as commercial SunTronic Jet Silver 06503, from Sun Chemicals Ltd. (485 Berkshire Av, Slough, UK).
Dissolved material—At least part of a solid material to be used to construct the object can be dissolved in the carrier liquid. An example of the dissolved material may include a dispersion of silver (Ag) particles and a fraction of Ag organic compound dissolved in the carrier liquid. After printing and during firing, the organic portion of the Ag organic compound fires off, leaving the metal silver atoms well spread. This ink is readily available, such as Commercial DYAG100 Conductive Silver Printing Ink, from Dyesol Inc. (USA), 2020 Fifth Street #638, Davis Calif. 95617.
Dispersing agent—In order to sustain particle dispersion, a dispersing agent, also known as dispersant, may assist in dispersing the particles in the carrier liquid. Dispersants are known in the industry, and are often a kind of polymeric molecule. In general, the dispersing molecules adhere to the solid particle's surface (i.e., wrap the particles) and inhibit agglomeration of the particles to each other. When more than one solid particle species is dispersed in the dispersion, using the same dispersant material for all solid particle species is described so compatibility problems between different dispersant materials are avoided. The dispersing agent should also be able to dissolve in the carrier liquid so that a stable dispersion can be formed.

According to some embodiments, additive manufacturing apparatus 100 may include an energy source, for example, energy source 112. The term “energy source” includes any device configured to supply energy to an object being printed by additive manufacturing apparatus 100. For example, supplying energy in the form of radiation or heat to new layer 124 may be used to evaporate the dispersant material and other organic additives and optionally initiate at least partial sintering between the object particles. In one example, energy source 112 may include a small spot size energy source, such as a lamp or a laser configured to irradiate or scan a line along new layer 124 in order to cause in situ debinding or sintering or at list partial sintering to a newly formed layer 124. In another example, energy source 112 may include a flash-lamp configured to cover an area of newly formed layer 124 in order to initiate partial or full in situ debinding or sintering. According to this aspect of the disclosure, energy source 112 may be configured to selectively sinter model ink only in order to avoid support ink sintering. Such a selectivity may be achieved by irradiating new layer 124 with wavelengths which are absorbed more in a model ink than in a support ink and/or by adding pigments to the model ink which increases its energy absorption to the irradiated wavelengths.

In a first embodiment, energy source 112 may be incorporated with printing region 102 to form a warm tray. When the printed object is being heated from below the heat constantly flows up to new layer 124, and because of the heat-flow resistance of the material, a temperature gradient is built, with high temperature at the bottom of the object and low temperature at the upper surface of the object (along the Z-axis). The temperature of the warm tray may be controlled higher and higher dependent upon the interim height of the object during printing, so as to keep the temperature of the upper-layer constant. In a second embodiment that is illustrated in FIG. 1A, energy source 112 may be located above the object being printed. The direct heating by the energy source 112 can assure constant temperature of new layer 124. The energy source 112 may be positioned aside print head 106, and can produce thermal radiation. In a third embodiment, energy source 112 may include an aperture configured to blow a stream of hot air on new layer 124. The use of hot air may increase the temperature of new layer 124 and also assist in evaporation of liquid carrier from new layer 124. In addition, a combination of any of the first, second, and third embodiments may be used to maximize the heating and/or evaporation performances.

As mentioned above, warming new layer 124 may be part of the additive manufacturing process. In some embodiments, however, the rest of the printed object should not be maintained at the same temperature as new layer 124. Accordingly, additive manufacturing apparatus 100 may include a cooling fan 114 for dissipating the heat stored in a recently printed layer to the surrounding air. One reason to cool a recently printed layer may be that when ink droplets land on a surface with a temperature high above the boiling temperature of a carrier liquid (e.g., by 30° C.) they may explode rather than attach to the surface, such as when water droplets land on a surface of 120° C. Thus, the rest of the object is not required to be maintained the same temperature as the temperature of new layer 124, only to be maintained at a constant and uniform temperature. For example, new layer 124 may be warmed to a temperature higher than the boiling temperature of the carrier liquid (e.g., new layer 124 can be warmed to about 500° C.) when the previously printed layers may be maintained at a relatively lower temperature (e.g., about 230° C.) using cooling fan 114.

In some embodiments, additive manufacturing apparatus 100 may also include a thermal buffer, such as shield 116. In the context of this document, a heat shield refers to a plate that partially covers the nozzles array and has an opening to facilitate printing from nozzles to the printing area. Because the printed object is relatively hot (e.g., about 230° C.) as compared to room temperature (e.g., about 25° C.), print head 106 should be protected from the heat and fumes emerging from the printing area. In one embodiment, shield 116 may be maintained at a relatively low temperature compared to the temperature of the object while being printed (e.g., from 10 to 50° C.) to provide a thermal barrier between the print head 106 and the printed object.

Due to a variety of reasons, including different jetting power of the different nozzles and liquid surface tension, new layer 124 may not be perfectly flat and the layer's edge may not be perfectly sharp. Therefore, additive manufacturing apparatus 100 may also include leveling apparatus 118 to flatten new layer 124 and/or sharpen one or more edges of new layer 124. In one embodiment, leveling apparatus 118 may include a vertical or horizontal grinding roller or cutting roller. In another embodiment, leveling apparatus 118 may include a dust filter 126 to suck the dust output of leveling. During the printing process, leveling apparatus 118 may operate on new layer 124 while the layer is being dispensed and solidified. In one example, leveling apparatus 118 may peel off between about 5% and 20% of material of the upper-layer's height. In some embodiments, leveling apparatus 118 meets the ink after the carrier liquid has evaporated and new layer 124 is at least partially dry and solid.

In some embodiments, additive manufacturing apparatus 100 may also include an imager, such as image sensor 128. The term “imager” or “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 128 may be part of a camera configured to capture printing region 102.

As mentioned above, additive manufacturing apparatus 100 can produce any object from a digital model. To do so, additive manufacturing apparatus 100 may include a processing device, such as controller 120, for controlling the operation of different printing components. According to some embodiments, controller 120 may include at least one processor configured to determine how to operate additive manufacturing apparatus 100. The at least one processor may constitute any physical device having an electric circuit that performs a logic operation on input or inputs. For example, the at least one processor may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by at least one processor may, for example, be pre-loaded into a memory integrated with or embedded into controller 120 or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative of products associated with the visual codes. In some embodiments, controller 120 may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically, or by other means that permit them to interact.

Consistent with the present disclosure, after the printing process has been completed, the object may be placed in a furnace for sintering. In some embodiments, the object may be fired in the furnace to a predetermined temperature until complete sintering occurs. The sintering process can include the following firing steps:
Initial warming to burn out all organic material;
Additional warming to liquidize inorganic additives, such as Cobalt (if included in the ink); and
Final warming to sinter the particles.
   Some of the firing steps can include applying vacuum, applying pressure, adding inert gas to prevent oxidation, and adding other gases that may add desired molecular diffusion or chemical reaction with the body.

As described above, additive manufacturing apparatus 100 may use liquid ink to create a solid object. Generally, the bigger the object, the more ink is required. Also, the higher the percentage of the solid particles in the ink, the less liquid ink is required to print a certain object. Some of the printing parameters may have conflicting characteristics and therefore an optimization may be required. For example, parameters which promote fast printing, such as solid particles load, may compete with other system requirements such as ink viscosity, to which inkjet printing heads are vulnerable. According to one embodiment, the suggested system can determine values of ink parameters and printing parameters based on characteristics of the system (e.g., the nozzles size) and the characteristics of the object to be printed. In one embodiment, additive manufacturing apparatus 100 is part of an industrial printing system capable of storing large quantities of ink in ink reservoir 110. To keep a certain pressure gradient across print head 106, ink flow could be carefully managed in additive manufacturing apparatus 100. The pressure gradient across print head 106 allows its proper functioning. In addition, since additive manufacturing apparatus 100 may include moving parts and stationary parts, certain ink flow parameters may be managed differently during printing times and non-printing times.

FIG. 1B depicts an example of an ink delivery system 150 for additive manufacturing apparatus 100. As shown, ink delivery system 150 has a first section, a second section, and a third section. In one embodiment, each section of ink delivery system 150 may be located at a different floor. For the simplicity of the following discussion it will be assumed that the first section is the lowest floor, the second section is the middle floor, and the third section is the highest floor. However, ink delivery system 150 is not limited to this configuration and it should be understood that the first section may be the highest floor and the third section may be the lowest floor. Also, as discussed below the second section may be higher than any other floor or even be the highest floor. In addition, in other configurations of ink delivery system 150, specific components depicted in a certain section may be found in other sections. As illustrated in FIG. 1B, a first section may include a first ink reservoir 110 (also referred to as main tank 152), a first ink pump 154A, a second ink pump 154B, a waste tank 156, ink module 158, and vacuum generator 160. First ink pump 154A may be configured to pump ink from main tank 152 to a second ink reservoir 110 (also referred to as secondary tank 162) located in the second section. Second ink pump 154B may be configured to pump ink from secondary tank 162 to main tank 152, for example, when additive manufacturing apparatus 100 enters a long non-printing period. Secondary tank 162 may be associated with one of more sensors 164 to monitor the state of ink and with a third ink pump 154C configured to pump ink to print head 106 at a plurality of predefined pressures via a supply conduit 165 interconnecting secondary tank 162 with print head 106. One of more sensors 164 may monitor the pressure at secondary tank 162, the temperature of the ink, the viscosity of the ink, and any other ink related parameters. The third section may include printing region 102 and print head 106. For simplicity of discussion, a single print head 106 is depicted and described; however, it should be understood that multiple print heads 106 may be used separately or as groups. The third section also includes, in proximity to print head 106, an air-ink separator 166, a fourth ink pump 154D, an ink circulation valve 168, and a vacuum valve 170. Air-ink separator 166 may be configured to receive a mixture of air and ink stream and to separate the mixture into two separate components: air and ink. Air-ink separator 166 may be connected to one or more return conduits 167 interconnecting print head 106 with the secondary tank 162 for circulating back at least a portion of the ink that was not expelled from print head 106.

Consistent with the present disclosure, ink delivery system 150 may include a plurality of floors corresponding with the plurality of sections, wherein at least one floor may be stationary and at least one other floor may be movable relative to the stationary floor. For example, the first floor may be stationary and may be connected to the second floor with means that allow the second floor to move relatively to the first floor along the printing direction. In one example, the second floor is connected using an X IGUS system and the X direction is the printing direction. The third floor is configured to move with the second floor however it is also configured to move relatively to the second floor along the Y direction, which is defined herein as the longitudinal axis of the orifice plate of the printing units, using, for example, a Y IGUS system.

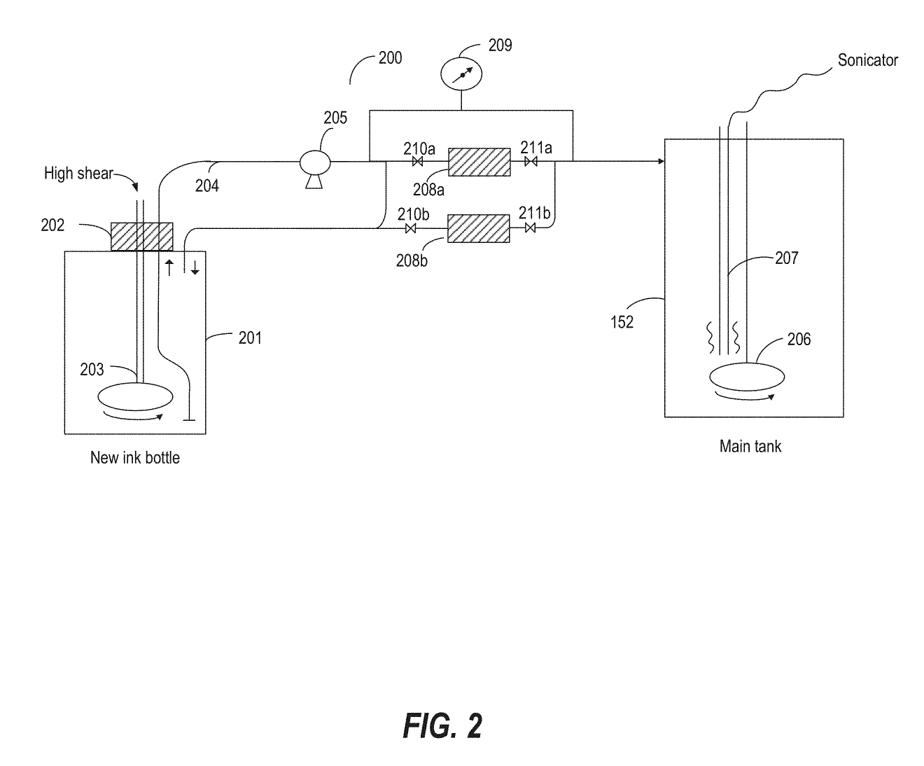

FIG. 2 is a schematic diagram illustrating different embodiments of an ink filling system 200 that may be part of ink delivery system 150. As mentioned above, solid particles in the ink tend to agglomerate and sink. Consistent with embodiments of the present disclosure, a system and a method for reviving ink after long storage periods is provided. In one example, the storage periods may be during non-printing time. During these periods, ink located in an ink reservoir 110 (e.g., main tank 152) may sink or agglomerate. In addition, storage periods may include when an ink cartridge is configured to store ink after manufacturing, to be shipped, and/or stored, and to feed a printing system, which needs an ink supply. Consistent with the present disclosure, a sonicator 207 may be used in ink reservoir 110. A sonicator is an ultrasound-based element that may be configured to vibrate in order to send ultrasound or shock waves into the ink and break agglomerates if they exist. As illustrated in FIG. 2, an ink bottle 201, which may be configured to store between 1 L and 3 L of ink, is configured to connect with a cap 202. Cap 202 may be connectable to an ink stirrer 203, which is configured to stir the printing material in ink bottle 201 and prepare the printing material for uploading into ink reservoir 110 that may be configured to store between 4 L and 10 L. Ink filling system 200 may include an ink uploading line 204. The terms “conduit,” “pipe,” and “channel” may also be used interchangeably in this disclosure with reference to the term “line.” As depicted, a peristaltic pump 205 may be configured to pump non-invasively printing material from ink bottle 201 through ink uploading line 204 to main tank 152. In one example, peristaltic pump 205 may pump ink at a rate of about two liters per minute.

In additional embodiments, main tank 152 may have a stirrer 206 configured to stir the ink and an external (not shown) or internal sonicator 207 configured to create ultrasound or shock waves in the ink and to break solid particles agglomerates, if they exist. Ink filling system 200 may include at least one filter 208 for filtering printing material along ink uploading line 204 before the printing material enters main tank 152. In one configuration, more than one filter 208 may be connected in parallel or serially as shown by filter 208a and 208b. In the illustrated configuration, a pressure sensor 209 may be connected in parallel to the filters and may provide an indication for a clogged filter to be replaced. According to one example of the present disclosure, one or more filters 208 may be configured to filter particles greater than 1 micron, greater than 2 microns, or greater than 3 microns. Ink filling system 200 may also include sensors associated with one or more filters 208 (not shown) that can identify when the printing material includes a large amount of particles greater than a predefined size, and trigger the operation of stirrer 206 and sonicator 207.

As depicted in FIG. 2, ink filling system 200 may include two or more valves positioned anywhere along ink uploading line 204. For example, the two or more valves may be positioned on both sides of each filter 208. Valves 210 (e.g., 210a and 210b) may be positioned closer to ink bottle 201 and valves 211 (e.g., 211a and 211b) may be positioned closer to main tank 152. In one embodiment, ink filling system 200 may close valves 210, such that printing material may be circulated by peristaltic pump 205 to further support the ink revival process done by the ink stirrer 203. To assist the ink revival process, ink bottle 201 may be associated with an internal sonicator or an external sonicator. In another embodiment, ink filling system 200 may open valves 210 and close valves 211, such that printing material can further be circulated through filters 208. In another embodiment, ink filling system 200 may open both valves 210 and valves 211 such that revived ink from ink bottle 201 may be uploaded into main tank 152.

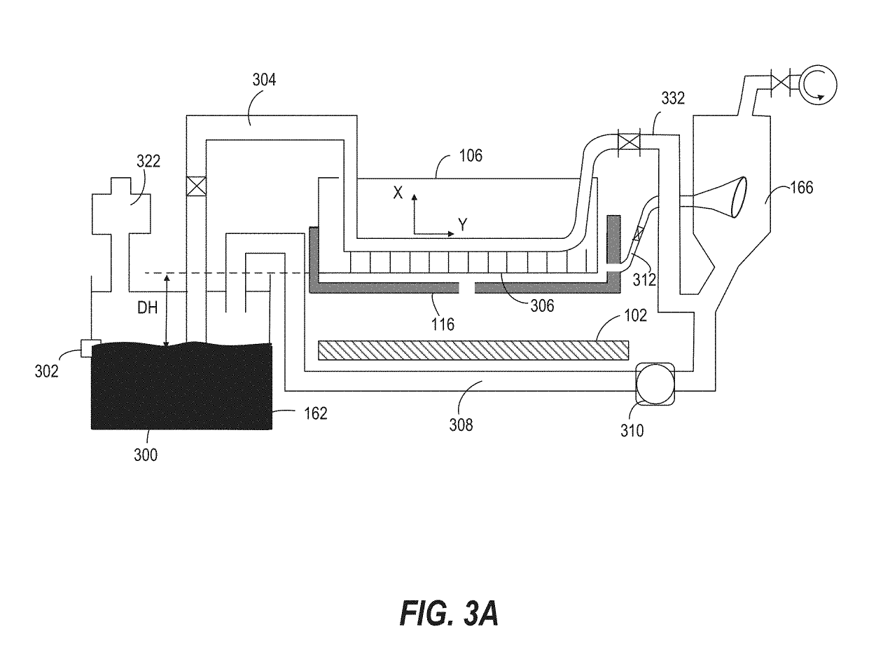

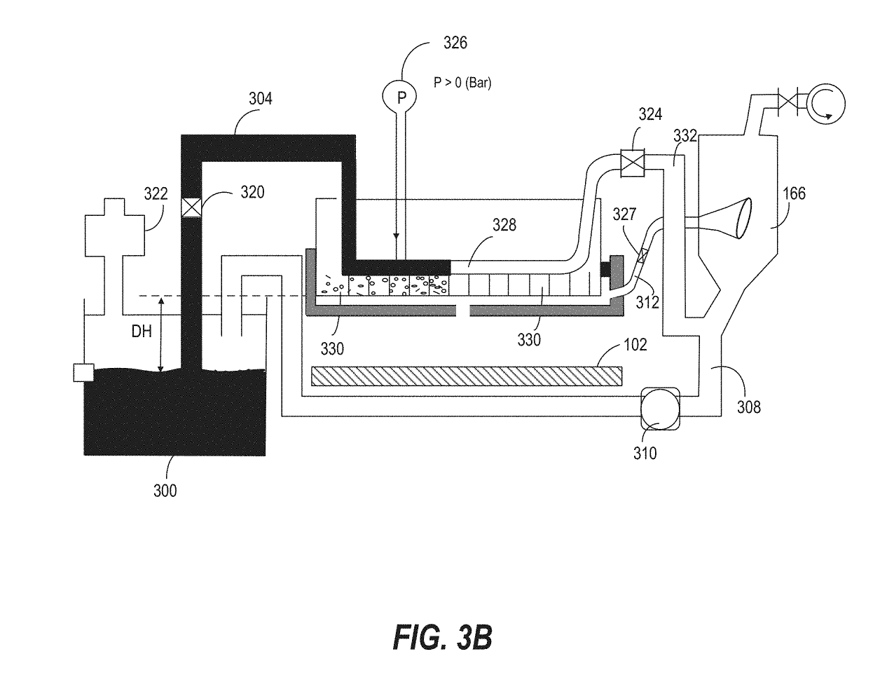

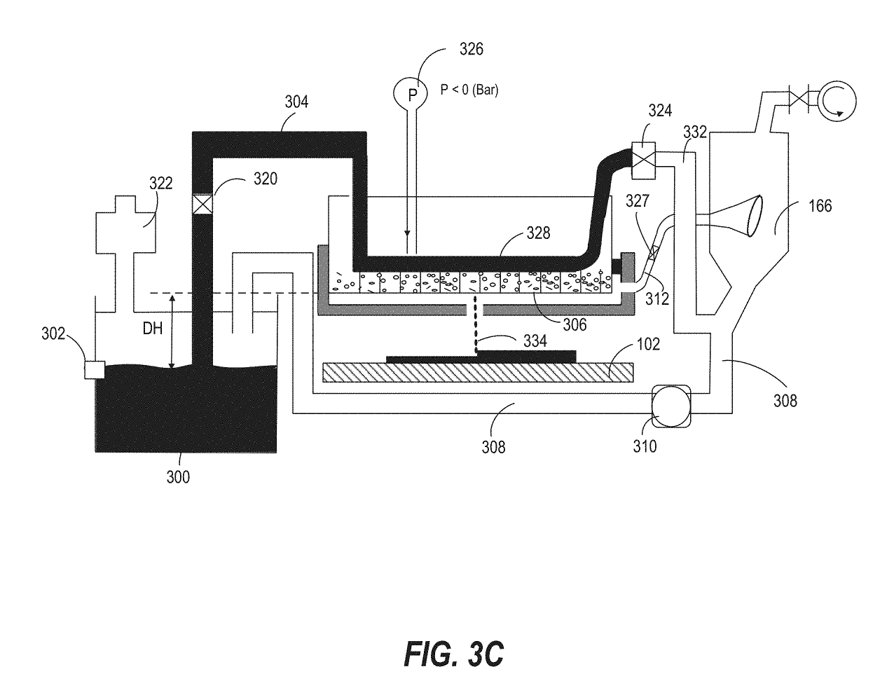

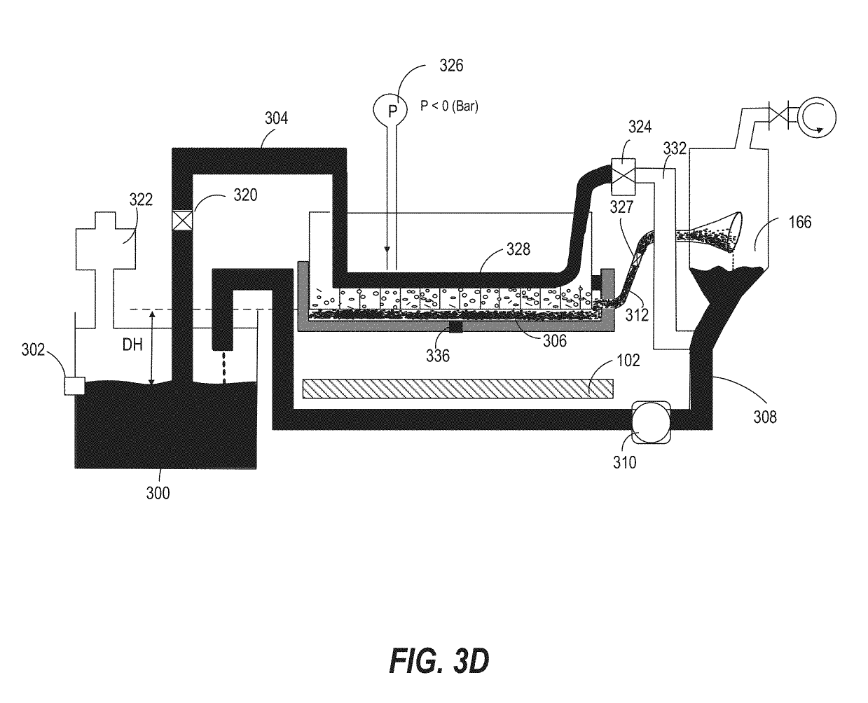

FIGS. 3A-3D illustrate other embodiments of ink delivery system 150. As mentioned above, once ink has been uploaded into main tank 152, pump 154B may upload ink from the first floor into secondary tank 162 located in the second floor. FIG. 3A is a schematic diagram illustrating one configuration for conveying ink from secondary tank 162 to print head 106. As illustrated in FIG. 3A, secondary tank 162 may be filled with ink 300. Controller 120 may use ink level sensor 302 to sense the ink level in secondary tank 162 and to control a pump (e.g., pump 154B) so that the ink level in secondary tank 162 may be maintained in a relatively precise range due to reasons that are discussed below. Ink channel 304 (e.g., supply conduit 165) may be configured to establish a fluid connection between secondary tank 162 and print head 106. Print head 106 further includes an orifice plate 306 located below a set of piezo electric cells, which are configured to jet ink. Shield 116 is configured to thermally isolate print head 106 from a hot tray. Ink circulation line 308 and ink circulation line 332 (e.g., return conduit 167) are configured to circulate ink, which passes through print head 106 back to secondary tank 162 by the assistance of ink pump 310. Ink purge line 312 is configured to draw purged ink from the capillary gap located between print head 106 and shield 116 into air-ink separator 166. In the example illustrated in FIG. 3A, ink 300 may be located only in the second floor (in secondary tank 162) and not yet uploaded to the third floor.

FIG. 3B is a schematic diagram illustrating another embodiment of ink delivery system 150. In one embodiment, ink delivery system 150 may include a regulator configured to control pressure of additive manufacturing material in print head 106 to, for example, trigger purging of print head 106 during a maintenance period. The term “regulator” or “pressure regulator” may broadly refer to any device configured to affect (directly or indirectly) the pressure of ink 300 in ink delivery system 150, for example, the regulator may include a flow restrictor associated with the any of ink conduits in ink delivery system 150, a variable pump associated with secondary tank 162 or with air-ink separator 166, or a valve interposed in any of ink conduits in ink delivery system 150. Consistent with this embodiment, valve 320 may be turned on such that positive pressure may be applied into secondary tank 162 to push ink into print head 106 and a negative pressure may be applied in air-ink separator 166 to pull ink into print head 106. Pressure switch 322 may be configured to control the pressure in secondary tank 162 and switches it from an atmospheric pressure into a positive pressure. Ink circulation valve 324 may be configured to control the pressure in air-ink separator 166 from an atmospheric pressure to a negative pressure. According to this aspect of the disclosure, the negative pressure in air-ink separator 166 may be varied in the range of about 0-(−0.5) bar, such as about 0-(−0.2) bar. Pressure sensor 326 may be configured to read the pressure along the main ink line 328 in print head 106 that distributes ink 300 into piezo cells 330. In one embodiment, a positive pressure gradient may be applied across orifice plate 306 to assure proper filling of piezo cells 330 with ink and to prevent air from entering into piezo cells 330 through their orifices. To accomplish the positive pressure gradient, ink circulation valve 324 may be turned on and drain valve 327 may be turned off to allow negative pressure from air-ink separator 166. Pressure sensor 326 may be configured to communicate with a controller (e.g., controller 120) to assure the positive pressure does not exceed a predefined value so that ink will not be induced to flow out of piezo cells 330.

FIG. 3C is a schematic diagram illustrating another embodiment of ink delivery system 150. In this embodiment, additive manufacturing apparatus 100 is loaded and ink droplets 334 are jetted toward printing region 102. Once a predefined positive pressure is read by pressure sensor 326, which indicates that print head 106 (or print heads) is properly filled with ink, pressure switch 322 turns off the positive pressure in secondary tank 162 in order to stop ink pushing into print head 106 and ink circulation valve 324 is turned off to stop ink pulling into print head 106. At this stage, the pressure in secondary tank 162 is about 0 Bar and pressure switch 322 is turned off. In this case, the pressure across orifice plate 306 may be mainly a function of ΔH, which may be defined by the height difference between the level of ink in secondary tank 162 and the level of orifice plate 306. According to one embodiment, the pressure gradient across orifice plate 306 should be kept slightly below the atmospheric pressure in order to allow proper performances of print head 106. As mentioned above, ink level sensor 302 monitors the level of ink in secondary tank 162 and assists in maintaining ΔH in a predefined range so that the pressure across orifice plate 306 may be maintained in an optimized negative range of about 1/100 Bar to about 5/100 Bar. In addition, due to the characteristics of the nozzle sizes of about 20 micron and due to the ink's surface tension, under this pressure gradient a meniscus of ink will be generated so that there is a steady state during non-printing time where ink does not flow out spontaneously from the piezo cells and, on the other hand, air does not flow into the piezo cells. Therefore, according to one embodiment of present disclosure, controller 120 may be configured to manage the height difference between the level of ink in secondary tank 162 and the level of orifice plate 306 (i.e., change ΔH), thereby managing the pressure gradient across the nozzles plate to achieve a steady state.

In some embodiments, ink circulation valve 324 may be off and the printing system may perform any of the following states: printing, purging, or non-printing. In other embodiments, ink circulation valve 324 may be turned on, and due to a relatively strong vacuum in air-ink separator 166 of about −0.2 Bar, exposing print head 106 to a low pressure. Exposing print head 106 to such a low pressure may cause most of the ink from print head 106 to be drawn out. Therefore, before opening ink circulation valve 324, it may be configured to increase the negative pressure in air-ink separator 166 to about −0.1 Bar. As mentioned above, the negative pressure gradient across orifice plate 306 may be about 1/100- 5/100. When the reduced vacuum level in air-ink separator 166 may be about −0.1 Bar, a spontaneous ink flow may start along main ink line 328 once ink circulation valve 324 is turned on. This spontaneous flow may continue as long as the negative pressure in air-ink separator 166 is lower than the negative pressure across orifice plate 306. Consistent with the present disclosure, the spontaneous flow may fill air-ink separator 166 with ink that is not required. Therefore, in this mode, ink pump 310 may be turned on. Ink pump 310 may be configured to keep the negative pressure in air-ink separator 166 at about a constant value of about −0.1 Bar and configured to circulate ink coming from print head 106 back into secondary tank 162. A vacuum sensor (not shown) in air-ink separator 166 may be configured to communicate with controller 120 that controls ink pump 310. In this mode of operation, where ink circulation valve 324 is open and ink flows along print head 106 through its main ink line 328, the pressure of the flowing ink along main ink line 328 is no longer only a function of ΔH (which is the case when ink circulation valve 324 is turned off) but rather also a function of the pressure difference between the pressure in secondary tank 162 and the pressure in air-ink separator 166. In other words, the pressure across orifice plate 306 may be equal to the pressure in secondary tank 162 minus the pressure in air-ink separator 166. Therefore, for example, if the pressure in secondary tank 162 is positive but the pressure in air-ink separator 166 is negative and if an absolute value is higher than the positive pressure in secondary tank 162, then still a negative pressure across the office plate may be maintained. Consistent with the present disclosure, the system may keep the pressure gradient across orifice plate 306 at about −0.01-(−0.05) Bar even if secondary tank 162 is higher than orifice plate 306 (negative ΔH). Therefore, according to another embodiment of the present disclosure, the second floor may be higher than the third floor.

FIG. 3D is a schematic diagram illustrating another embodiment of ink delivery system 150. In this embodiment, a complete ink circle using air-ink separator 166 during purge is illustrated. Specifically, as illustrated, a night plate 336 may seal the one or more jetting slits in shield 116. In one embodiment, ink found in a gap between print head 106 and shield 116 may be sucked into air-ink separator 166 and reenter ink delivery system 150 from a port (not shown) in air-ink separator 166. Specifically, air-ink separator 166 may be connected to at least one conduit (e.g., 308) for conveying additive manufacturing material from air-ink separator 166 to secondary tank 162 and from there to print head 106, thereby enabling reclaimed additive manufacturing material collected in air-ink separator 166 to be utilized for manufacturing a three-dimensional object. In this embodiment, pump 310 may be configured to circulate ink coming from air-ink separator 166 back into secondary tank 162.

As mentioned above, the pressure gradient may be a function of the pressure prevailing in secondary tank 162 and the negative pressure in air-ink separator 166. During printing, the pressure in secondary tank 162 may be 0 Bar and the pressure in air-ink separator 166 may be a reduced vacuum left in air-ink separator 166 after releasing part of the vacuum to the open atmosphere. During a removal of excess additive manufacturing material from orifice plate 306 (i.e., purging), the pressure in secondary tank 162 and the negative pressure in air-ink separator 166 may be controlled by different pumps in ink delivery system 150. Consistent with the present disclosure, print head 106 may have an ink input port (not shown) and an ink drain port (not shown). The ink input port may be configured to accept ink from secondary tank 162 through ink channel 304, and the ink drain port may be configured to drain ink out of print head 106 through ink circulation line 332. Main ink line 328 resides in print head 106 and is configured to connect the ink input port and the ink drain port. Main ink line 328 may also be configured to feed piezo cells 330 with ink for printing or purging purposes. Specifically, ink droplets 334 may reach printing region 102 during printing or may be collected back into secondary tank 162 during purging.

According to one embodiment of the present disclosure, purging may be done in the context of extended non-printing time when print head 106 is immersed in an ink retainer, such as by using night plate 336 which seals the jetting slits in shield 116. Additional details on the ink retainer are disclosed in U.S. Pat. No. 9,193,164, the content of which is incorporated herein by reference. One embodiment of purging using the ink retainer comprises first, sucking the ink from the ink retainer, and then performing the purge, which also fills back the retainer with ink. Sucking can be done either by a pipe in the retainer (e.g., ink purge line 312) or by print heads themselves. Another embodiment is performing a purge simultaneously with purge suction (by a retainer pipe) and when this is done continue sucking until completely emptying the retainer from ink, followed by additional purging to fill back the retainer. Either during purging and/or during sucking, the nozzles are optionally operated as in print jetting mode. Operating the nozzles as in jetting mode (labelled as “fire-all”) is also optionally done between purge/purge-suction cycles. In that case, ink-in and circulation valves may be turned off, and orifice plate 306 may be immersed in ink. Thus the ink that is pushed out of print head 106 during the positive pulse in the nozzle cell may be pumped back to print head 106 following the negative pulse.

The specified process above can be used not only during extended non-printing time, but also as a maintenance procedure of print heads 106. According to this embodiment, at least one print head 106 may be moved to a service area where it gets immersed in an ink retainer. Shield 116 can be used as an ink retainer when its jetting slits are sealed by night plate 336. Thereafter, additive manufacturing apparatus 100 may perform a maintenance procedure of purging and may be followed by ink sucking (particularly sucking by the head nozzle) and fire-all during (or not during) purging. The maintenance procedure can be performed according to a predetermined schedule (e.g., every hour), or every 200 printed layers, or between print jobs, as well as be a procedure to improve nozzles performance when print head 106 is not printing properly. According to another embodiment of the present disclosure, additive manufacturing apparatus 100 is configured to purge print head 106 during a maintenance period. The term “maintenance period” broadly refers to any period of time that additive manufacturing apparatus 100 is not used for manufacturing a three dimensions object. In one example, the maintenance period may include short non-printing time such as after finishing printing one layer and before moving to print the next layer, or between successive printing sessions. As mentioned above, purging during short non-printing time may be done by collecting purged ink, which may be ejected through and by nozzles into a gap between print head 106 and shield 116. According to one embodiment of the disclosure, there are two types of purging during normal printing that involve ink circulation valve 324.

In the first type of purging, ink circulation valve 324 may be in an open state and some residual ink may be continuously drained from print head 106 through ink purge line 312. This type of purging may be referred to hereinafter as “circulation,” since the ink is continuously circulated from secondary tank 162 through print head 106 and back to secondary tank 162. The part of the flow in ink channel 304 that feeds the nozzles of print head 106 for the actual jetting is substantially greater in comparison to the part that is circulated back to the reservoir through ink purge line 312. In one embodiment, the flow in “circulation” is small, so that the hydraulic pressure gradient of the ink along main ink line 328 may be small. Because low circulation flow may lead to clogging, purging during short periods of non-printing is done by turning off ink circulation valve 324 and turning pressure switch 322 into a second state so that positive air pressure is applied inside secondary tank 162. According to one example, pressure in secondary tank 162 may be increased to an about 0.5-2 Bars. According to another example pressure in secondary tank 162 may be increased to about 1-1.5 Bars.

In the second type of purging, ink circulation valve 324 may be in a closed state. In this type of purging the pressure within secondary tank 162 may be increased while drain valve 327 is switched off, and ink is pushed along ink channel 304 and main ink line 328 in a much higher flow rate than the flow rate during printing, and therefore can clean and open settled or clogged material from the system. Purging during short periods of non-printing time may take about 0.5-4 seconds. According to one non-limiting example, purging during short periods of non-printing time may take about 2 seconds. According to one embodiment, since the flow of circulated ink through ink purge line 312 during printing state is weak, during purging state drain valve 327 may be opened for a short period of time (e.g., ⅓ of the purge time) in order to run a boost of high ink flow along ink purge line 312 for cleaning and maintenance purposes of ink purge line 312.

According to one embodiment, maintenance procedures are provided for print head 106 during a long continuous printing session. A long continuous printing session may be more than an hour, more than 3 hours, more than 5 hours, more than 12 hours, or more than 24 hours. During non-printing periods, service and maintenance procedures can be executed in order to restore or improve performances of print head 106. However, these maintenance procedures may consume expensive time and delay the print. Therefore, short non-printing times, such as the time laps between printing successive layers, may be used to drive some ink circulation and pulsation within print head 106. In this way, the time period between the maintenance procedures is reduced and speed of printing is increased. According to one example method, referred to hereinafter as “tickling,” the piezoelectric elements of the nozzles in print head 106 are activated on a sub-threshold energy level and at a frequency of about 0.5 kHz-2.5 kHz. In this sub-threshold level, the piezoelectric elements may provide insufficient energy to the ink volume contained in the nozzle to initiate a droplet. In one embodiment, controller 120 may control and synchronize between short non-printing periods and sub-threshold voltage or current delivered to print head 106. The push/pull pulses during sub-threshold activation of the piezoelectric elements may create a micro pressure pulsation of the ink contained in the nozzles.

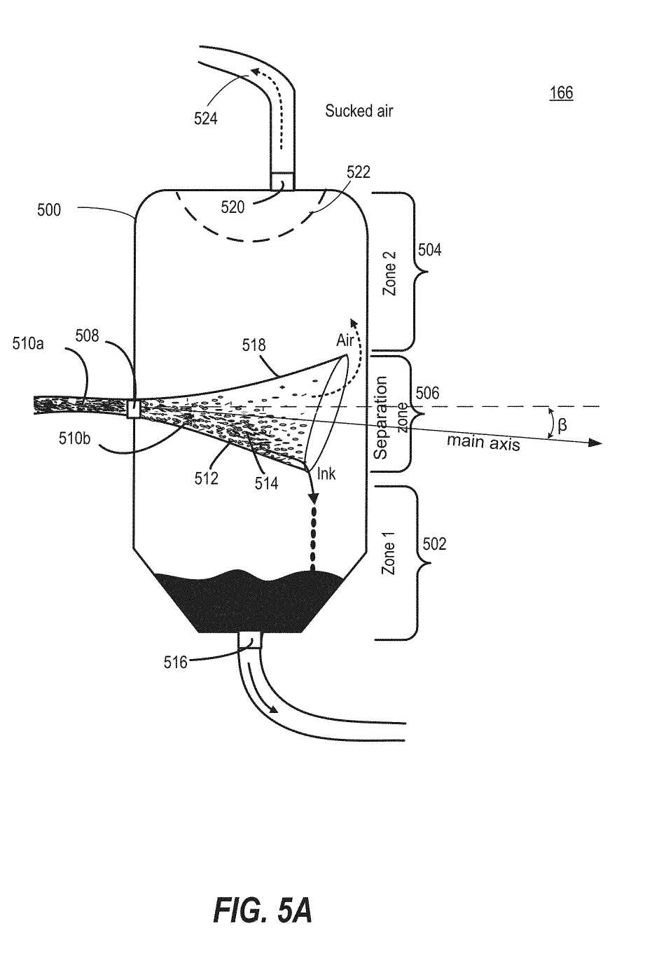

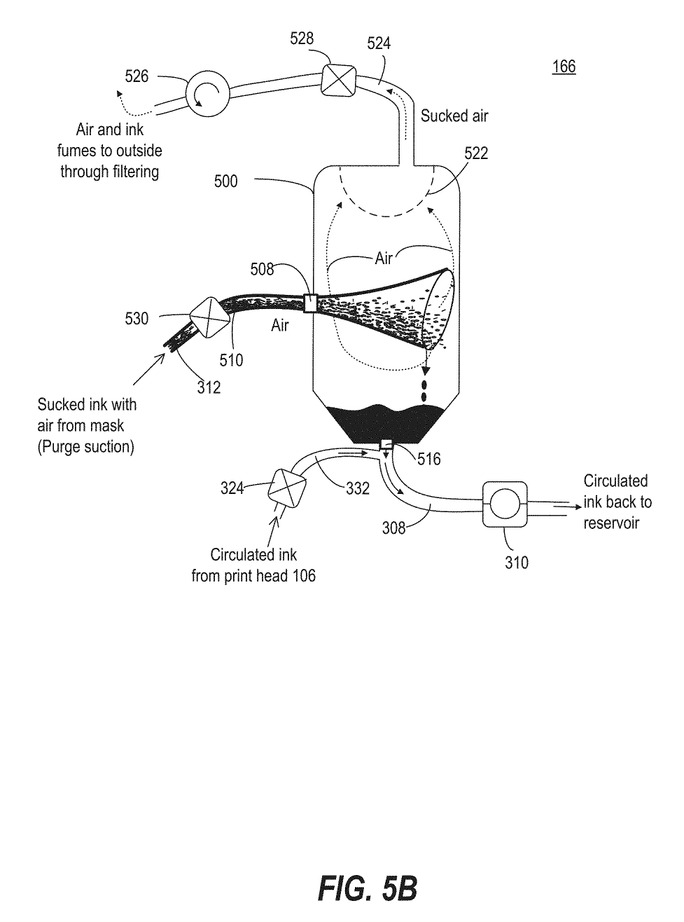

According to another embodiment, a maintenance process is provided. In the maintenance process a positive pressure of about 1 Atm may be created in secondary tank 162 while drain valve 327 is turned off. Ink purge line 312 is connected to a negative pressure source, such as air-ink separator 166, through another valve (shown in FIG. 5B). Pulsating ink movements may be created in print head 106 by alternating drain valve 327 and the another valve from an “off state” to an “on state” in an opposite fashion, resulting in alternating positive and negative pressure pulse respectively. In one example, the positive pressure pulses may last for about 0.5 sec and the negative pressure pulses may last for about 0.3 sec. In another example, the positive pressure pulses may last for about 0.3 sec and the negative pressure pulses may last for about 0.15 sec. A series of about 1-6 pulses may be generated during short non-printing periods. During the negative pressure pulses, ink may be drained from print head 106. During the positive pressure pulses ink may be supplied into print head 106 and ink may leak from the nozzle orifice and wet orifice plate 306 without dripping off print head 106. Thereafter, a subsequent negative pulse may suck the ink back into print head 106 before a drop can be accumulated and drip from orifice plate 306.

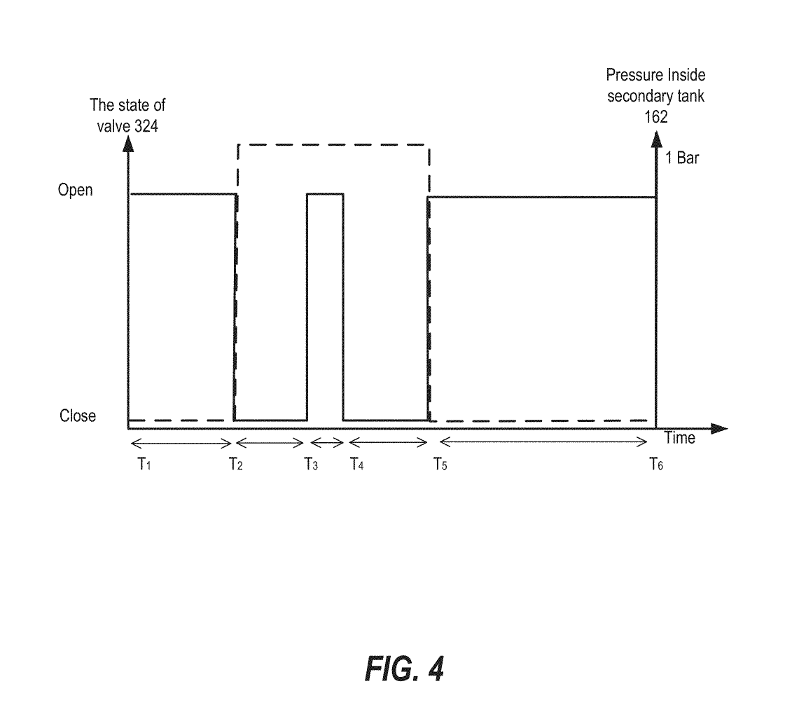

FIG. 4 displays a diagram that illustrates the above process. In the diagram the X-axis represents the time, the Y₁-axis on the left side shows the state of ink circulation valve 324, and the Y₂-axis on the right side shows the pressure inside secondary tank 162. The solid line in the diagram refers to the ink circulation valve 324 state and the dashed line refers to the pressure level in secondary tank 162. The time periods T₁-T₂ and T₅-T₆ describe normal printing periods in which ink circulation valve 324 is in the first position (i.e., open) and the pressure in secondary tank 162 is an ambient pressure. During this time some ink may circulate through ink circulation line 332. The time period T₂-T₃ is a non-limiting example for a purge which is being done during a short period of non-printing time. At time T₂ purge starts by switching ink circulation valve 324 to the second position (i.e., closed) by an increased pressure in secondary tank 162. Pressure is increased in secondary tank 162 by turning pressure switch 322 into a state so that positive air pressure is applied inside secondary tank 162. Also the diagram shows that at time T₃ ink circulation valve 324 may be switched on for a short period until time T₄. Such a small period is only a fraction of the total purge duration (e.g., ⅓ of the purge time) and can extend, for example, about 0.5 second.

Consistent with the above discussion, an additive manufacturing apparatus (e.g., additive manufacturing apparatus 100) may be provided. The additive manufacturing apparatus may include a reservoir configured to contain additive manufacturing material (e.g., secondary tank 162), and a supply conduit (e.g., ink channel 304) interconnecting the reservoir with a print head (e.g., print head 106) for supplying the additive manufacturing material to the print head. As mentioned above, the print head may include a plurality of orifices for expelling the additive manufacturing material. The additive manufacturing apparatus may also include a return conduit (e.g., ink circulation line 332), interconnecting the print head with the reservoir for circulating back to the reservoir at least a portion of the additive manufacturing material that was not expelled from the print head. The additive manufacturing apparatus may also include a return conduit and a regulator (e.g., ink circulation valve 324), configured to control the pressure of additive manufacturing material in the print head and a flow rate of additive manufacturing material in the return conduit. The regulator may be associated with at least one processor (e.g., controller 120) configured to, during a printing operation, maintain normal printing operating pressure in the print head. The at least one processor may also be configured to, during a maintenance operation, trigger at least one of: purging the print head by increasing pressure in the print head beyond the normal printing operating pressure in order to cause additive manufacturing material to expel through orifices of the print head at a rate greater than during the printing operation; and purging the return conduit by increasing a flow rate in the return conduit such that the flow rate in the return conduit during the maintenance operation exceeds a flow rate in the return conduit during the normal printing operation.

In related embodiments, the regulator may include a flow restrictor associated with the return conduit, a variable pump associated with the reservoir, or a valve interposed in a return flow path between the print head and the reservoir. In a first example, the regulator may include a variable pump associated with the reservoir, and where the at least one processor may include a pump controller for causing the pump to increase pressure in the reservoir. In a second example, the regulator may include a valve associated with the return conduit, and where the at least one processor may include a valve controller for selectively restricting flow through the return conduit. In a third example, the regulator may include a valve associated with the return conduit and a pump associated with the reservoir, and where the at least one processor may include a controller for selectively restricting flow through the return conduit and for causing the pump to increase pressure in the reservoir.

Consistent with some embodiments, the at least one processor may be configured to purge both the print head and the return conduit in a single maintenance operation. In addition, the at least one processor may be configured to sequentially alternate between the printing operation and the maintenance operation, with the maintenance operation lasting no longer than five seconds. In one case, the at least one processor is configured, during maintenance operation, to increase pressure in the print head above 0.5 Bar. In another case, the at least one processor is configured, during maintenance operation, to increase pressure in the print head above 1 Bar. Moreover, the at least one processor is further configured to automatically switch between the printing operation and the maintenance operation in response to a trigger. The trigger may be selected from the group consisting of: a predetermined time lapse, a predetermined volume of additive printing material expended, a predetermined number of layers printed, a detected print head condition, and an end of a print job. In other embodiments, the at least one processor may be configured to trigger the maintenance procedure during extended periods when the print head is not being used for manufacturing. In addition, the additive manufacturing apparatus may include a vessel (air-ink separator 166) for collecting additive manufacturing material expelled through the orifices during purging the print head. The additive manufacturing apparatus may include an additional conduit (e.g., ink purge line 312) interconnecting the vessel with the reservoir for circulating back to the reservoir additive manufacturing material expelled during the purging.

In another aspect of the disclosure, a method is provided for operating an additive manufacturing apparatus. The method comprises: supplying, via a supply conduit, additive manufacturing material from a reservoir to a print head, wherein the print head has a plurality of orifices for expelling the additive manufacturing material; circulating back to the reservoir, via a return conduit, at least a portion of the additive manufacturing material that was not expelled from the print head; controlling pressure of additive manufacturing material in the print head and a flow rate of additive manufacturing material in the return conduit, such that: during a printing operation, normal printing operating pressure is maintained in the print head; during a maintenance operation, a purging event is triggered, wherein the purging event includes at least one of: purging the print head by increasing a pressure in the print head beyond the normal printing operating pressure in order to cause additive manufacturing material to expel through orifices of the print head at a rate greater than during the printing operation; and purging the return conduit by increasing a flow rate in the return conduit such that the flow rate in the return conduit during the maintenance operation exceeds a flow rate in the return conduit during the normal printing operation.

### Air-Ink Separator

FIG. 5A is a schematic illustration depicting the operation of an apparatus (e.g., air-ink separator 166) used for extracting additive manufacturing material (e.g., ink 300) from a stream of air containing droplets of additive manufacturing material. In one embodiment, air-ink separator 166 may be used during non-printing periods and the extracted additive manufacturing material may be reused for printing or any other purpose. Consistent with the illustrated example, air-ink separator 166 may include a reservoir (e.g., a chamber 500) connectable to additive manufacturing apparatus 100. The reservoir may have a first zone 502 for collecting additive manufacturing material, a second zone 504 for collecting air, and a separation zone 506 intermediate the first zone and the second zone. The term “zone” as used herein refers to a space within the reservoir that is associated with a particular function. In one example, the borders between the zones may be physically defined, for example, by a border element. In another example, the borders between the zones may be logically defined. As illustrated in FIG. 5A, chamber 500 may include a stream inlet 508 configured to be connected to input pipe 510 (e.g., ink purge line 312) that is configured to deliver a mixture of air and ink into chamber 500. In other words, stream inlet 508 is being flow-connected to an outlet of input pipe 510 and is being configured to supply a stream of air and additive manufacturing material droplets to separation zone 506. Input pipe 510 may be used to pull the stream of air containing droplets of additive manufacturing material from a space between orifice plate 306 and shield 116 into the air-ink separator 166. Input pipe 510 may be part of or connectable to ink purge line 312.

In one example configuration, input pipe 510 may have two parts: a first portion 510a external to chamber 500 and a second portion 510b inside chamber 500. In this example configuration, first portion 510a may be extended outwards from a wall of chamber 500 and may be associated with an opening at first diameter, and second portion 510b may be connected to first portion 510a and extend inwards from the wall of chamber 500. Consistent with the present disclosure, second portion 510b may be formed in a shape of a cone, a funnel, or a trumpet and its distal end may have an opening at second diameter. Typically, the second diameter may be greater than the first diameter. For example, the second diameter may be at least two times greater than the first diameter, at least four times greater than the first diameter, or at least five times greater than the first diameter. The term diameter as used herein refers to an approximation of the width of the opening and not to the technical geometric term. For example, each of first portion 510a and second portion 510b may have a cross-section that is round, triangular, square, rectangular, oval, or any other regular or irregular shape and the first and second diameters represent a dimension associated with a width of a corresponding opening.

Consistent with the present disclosure, the velocity of the stream of air and additive manufacturing material droplets inside input pipe 510 may be a function of the pressure gradient applied along input pipe 510 and the diameters of the different parts of input pipe 510. A detailed discussion of the pressure gradient is provided with reference to FIG. 3D. In one embodiment, air-ink separator 166 may be designed to lower the velocity of the stream at the output of second portion 510b, so that ink droplets or spray will not energetically fly up and be sucked by an air conduit 524. As the second diameter of the distal end of second portion 510b is greater than the first diameter of first portion 510a, the velocity of the mixture inside the second portion 510b decreases. According to one embodiment of the present disclosure, the distal end of second portion 510b may have a cone shape. According to another aspect of the disclosure the orientation of second portion 510b is such that it may be relatively horizontal. For example, angle β between the main axis of second portion 510b and the horizon may be lower than 30 degrees, lower than 15 degrees, or lower than 5 degrees. In addition, second portion 510b may be configured to eject a mixture of air containing droplets of additive manufacturing material against a portion of chamber 500 wall allowing a further reduction of the mixture velocity. Moreover, the cone shape distal end of second portion 510b may not be symmetrical along its main axis to provide more room for ink droplets to spontaneously fly or fall toward first zone 502 while providing less room for ink droplets to go up to second zone 504. This structure, together with a filter 522, may reduce the amount of droplets and vapors sucked into an air outlet 520.

In another example configuration, second portion 510b may be part of air-ink separator 166 and may include a device interposed between separation zone 506 and first zone 502 and being positioned such that additive manufacturing material droplets entering the reservoir through the stream inlet traverse at least a portion of the device for deposition thereon. In one embodiment, the device may include a barrier (e.g., barrier 512) that is configured to prevent droplets from the stream to fall into first zone 502 and enables air from the stream to reach second zone 504 for evacuation through the air outlet. Barrier 512 may be positioned such that additive manufacturing material droplets 514 entering chamber 500 through stream inlet 508 traverse at least a portion of barrier 512 for deposition thereon. In one example, the term “traverse at least a portion of barrier” means that one or more droplets slide on barrier 512. Additionally, barrier 512 may be structured to cause additive manufacturing material droplets 514 deposited thereon to drop into first zone 502 for evacuation through an ink outlet 516 located in first zone 502 for additive manufacturing material. Specifically, barrier 512 may include a region that is sloped toward first zone 502 to facilitate run off of additive manufacturing material droplets 514 into first zone 502. In addition, second portion 510b may further include a second barrier 518 interposed between separation zone 506 and second zone 504. Second barrier 518 defines a limited space between separation zone 506 and second zone 504 so that air from the stream is enabled to reach second zone 504 for evacuation through air outlet 520 located in second zone 504. In this context, a “limited space” is an open area bounded by at least two surfaces that may be curved or straight (e.g., barrier 512 and second barrier 518. Second barrier 518 may be configured to at least partially impede additive material droplets 514 from reaching second zone 504.

Consistent with the configuration above, barrier 512 and second barrier 518 may be unitarily formed in a shape of a funnel. Specifically, the funnel may be oriented to direct the stream from one wall of chamber 500 toward an opposing wall of chamber 500. In one embodiment, barrier 512 and second barrier 518 may be integrally formed as a unit, and the unit may have an asymmetrical shape with respect to its main axis. For example, second barrier 518 may have a first length and barrier 512 may have a second length, wherein the first length is greater than the second length. In a first configuration, the first length may range from 105% to 155% longer than the second length. In a second configuration, the first length may range from 115% to 145% longer than the second length. In a third configuration, the first length may range from 110% to 125% longer than the second length.

In one configuration, barrier 512 and second barrier 518 may be separated from each other. Alternatively, and as discussed above, barrier 512 and second barrier 518 may be integrally connected and constitute a part of input pipe 510. Specifically, in one embodiment, air-ink separator 166 may include a funnel-shaped pipe (e.g., input pipe 510) oriented to direct the mixture of air and additive manufacturing material from one side of air-ink separator 166 toward an opposing side of air-ink separator 166. The funnel-shaped pipe's diameter gradually increases from the input to the output of the pipe. As shown in FIG. 5B an upper surface of the funnel-shaped pipe ends closer to a wall of air-ink separator 166 than a lower surface of the funnel-shaped pipe, to encourage ink droplets to flow toward down toward first zone 502 for collecting additive manufacturing material and not toward second zone 504 for collecting air.

In additional embodiments, air-ink separator 166 may include a filter 522 in second zone 504. Filter 522 may be configured to impede additive manufacturing material droplets 514 from reaching air outlet 520. Specifically, filter 522 may be configured to separate air from Nano-sized particles. For example, filter 522 may be a 0.2 μm nylon membrane filter. Air outlet 520 may be also connected to air conduit 524 for removing air from second zone 504. Moreover, air-ink separator 166 may include a device located adjacent ink outlet 516 (not shown) configured to generate a magnetic field for attracting additive manufacturing material droplets 514 toward first zone 502. In one embodiment, the magnetic field may be generated by an electric current. In another embodiment, the magnetic field may be generated by one or more magnets.

FIG. 5B is another schematic illustration depicting the operation of air-ink separator 166. Specifically, FIG. 5B illustrates how air-ink separator 166 connects to additive manufacturing apparatus 100. In one embodiment, stream inlet 508 may be flow-connected to a conduit (e.g., ink purge line 312) interconnecting chamber 500 with print head 106 for circulating back to chamber 500 at least a portion of the additive manufacturing material that was not expelled from printing orifices of print head 106. In one example, air-ink separator 166 may be connected to a variable speed pump associated with stream inlet 508, wherein the variable speed pump is configured to deliver a stream to stream inlet 508 at a first rate during a printing operation and is configured to deliver the stream to stream inlet 508 at a second rate, greater than the first rate, during a purging operation. In addition, air-ink separator 166 may include a pump 526 configured to reduce the gas pressure in chamber 500, thereby pulling the mixture of ink and air through input pipe 510. Pump 526 may also be used to circulate air and ink vapor out of chamber 500, for example, to a gas and vapors treatment module (not shown).

When air-ink separator 166 is operatively connected to additive manufacturing apparatus 100, input pipe 510 may be in a fluid communication with ink purge line 312 such that ink mixed with air may be sucked from a space between orifice plate 306 and shield 116 during purge/purge-suction events. In order to circulate ink from and to air-ink separator 166, controller 120 may use at least one valve for controlling the pressure in the chamber 500. The at least one valve may include: ink circulation valve 324, vacuum valve 528, and suction valve 530. The circulation of the ink may be energized by the pressure gradient along ink purge line 312 and input pipe 510. During a purge-suction period, vacuum valve 528 and suction valve 530 may be open and ink circulation valve 324 may be closed. In this scenario, the ink flow into chamber 500 may be substantially high, and thus ink may accumulate in the bottom of chamber 500. At that time, ink pump 526 may operate at high pumping power. During printing the opposite occurs. Specifically, a vacuum condition (or a close-to-vacuum condition) in air-ink separator 166 is desired during printing in order to establish ink circulation and to establish a (small) negative pressure in print heads 106. In this scenario the flow of the circulated ink is small; therefore during a printing period ink pump 526 may operate at a lower power than during a purge-suction period. In a related embodiment, air-ink separator 166 may include an additional valve: atmosphere valve, which may be permanently closed except during a small period of time after vacuum valve 528 is turned off in order to reduce the vacuum in air-ink separator 166. In addition, any ink accumulated in chamber 500 may be substantially completely pumped off before a successive purge-suction period.

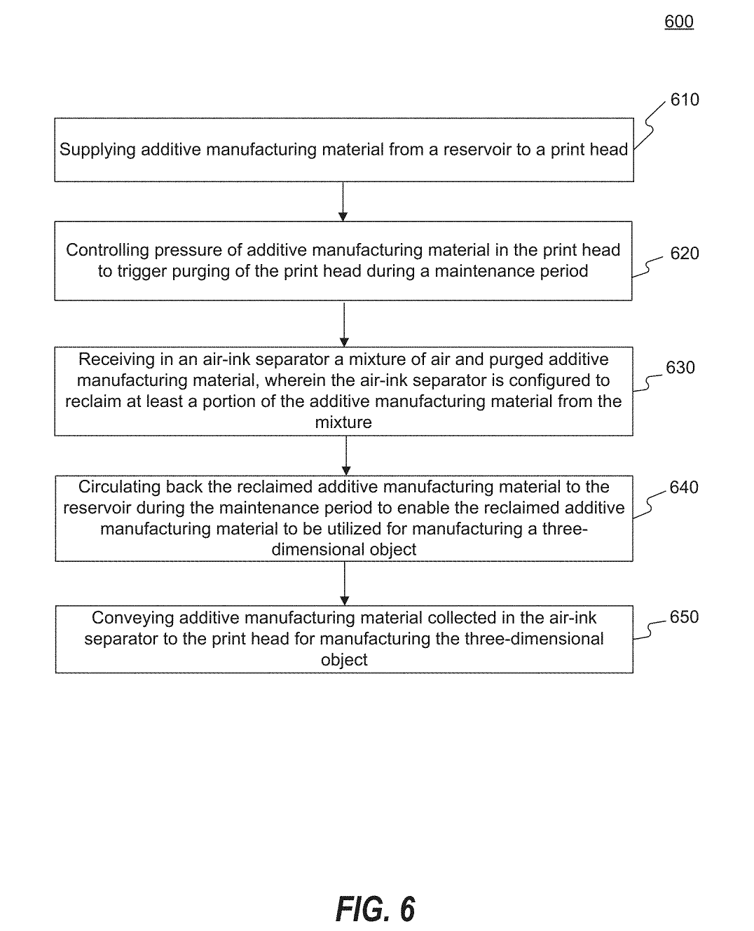

FIG. 6. is a flowchart of example process 600 for extracting printing material from a stream of air containing droplets of printing material, in accordance with some embodiments of the present disclosure. In one embodiment, all of the steps of process 600 may be performed by an additive manufacturing apparatus, such as additive manufacturing apparatus 100 that includes a dedicated device for extracting printing material, such as air-ink separator 166. In the following description, reference is made to certain components of additive manufacturing apparatus 100 and air-ink separator 166 for purposes of illustration. It will be appreciated, however, that other implementations are possible and that other components may be utilized to implement example methods disclosed herein. It will also be appreciated that the illustrated method can be altered to modify the order of steps, delete steps, or further include additional steps.

At step 610, additive manufacturing apparatus 100 may supply additive manufacturing material from a reservoir (e.g., secondary tank 162) to print head 106. Thereafter, at step 620, additive manufacturing apparatus 100 may control pressure of additive manufacturing material in print head 106 to trigger purging of print head 106 during a maintenance period. At step 630, air-ink separator 166 may receive a mixture of air and purged additive manufacturing material, wherein air-ink separator 166 is configured to reclaim at least a portion of the additive manufacturing material from the mixture. At step 640, additive manufacturing apparatus 100 may circulate back the reclaimed additive manufacturing material to the reservoir during the maintenance period to enable the reclaimed additive manufacturing material to be utilized for manufacturing a three-dimensional object. At step 650, additive manufacturing apparatus 100 may convey additive manufacturing material collected in air-ink separator 166 to print head 106 for manufacturing the three-dimensional object.

### Cold Plate

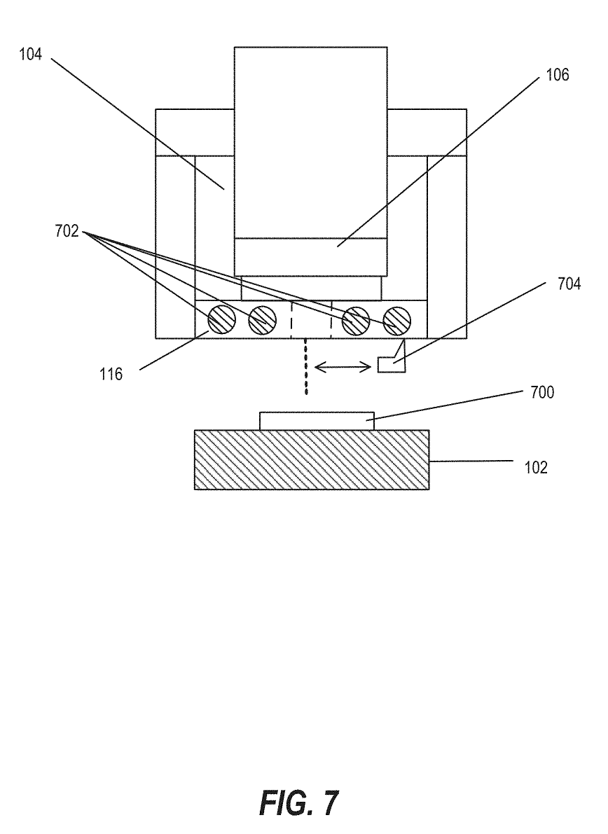

FIG. 7 is a schematic illustration depicting the operation of a second component of additive manufacturing apparatus 100 used for preventing condensed fumes from dripping on the three-dimensional object. As discussed above, additive manufacturing apparatus 100 may include print head 106 and a printing tray (e.g., printing region 102) supporting a three-dimensional object 700 to be constructed layer-by-layer in an additive manufacturing process. FIG. 7 also depicts print head holder 104 for maintaining print head 106 spaced from the printing tray, wherein print head 106 includes a plurality of nozzles configured to dispense an ink composition of a carrier liquid and object particles. Consistent with the present embodiment, shield 116 may include at least one cooling channel 702 having a fluid communication with a cooling system, which is configured to circulate coolant through shield 116. The cooling system may be controlled by controller 120 to adjust the temperature shield 116 at a required temperature. For example, by changing the flow of the coolant through the shield 116, different amounts of heat may be evacuated from the print head area. Therefore, print head 106 may be maintained at an optimum range of temperatures, e.g., 20-50 degree centigrade based on the ink viscosity requirements to be inkjetable. A sensor (not shown) may be configured to monitor the temperature of the coolant as it leaves shield 116 or a sensor that is configured to monitor the temperature of shield 116 itself or any other element that is indicative to shield 116 temperature may be used in order to provide feedback to the controller, which controls the cooling system. One example for the cooling system is disclosed in U.S. Pat. No. 9,340,016, the content of which is incorporated herein by reference. Typically, during printing over a hot substrate the temperature of shield 116 may vary as a function of different factors. Among them, for example, are the speed of printing, amount of ink printed, distance from substrate, temperature of substrate, air circulation within the printing chamber, coolant flow, and more. Therefore, dynamic temperature behavior may be predicted and can be managed by controlling at least part of these parameters.

According to one embodiment, the cooled and thermally managed shield 116 may be configured to also be considered as a condensation surface on which fumes of a volatile liquid that is evaporated from the printing area may condensate. A metal ink contains relatively large amounts of dispensing liquids in order to make it inkjetable. As a result of the relatively large amount of dispensing liquid in the ink, large amounts of fumes are generated and need to be managed. As mentioned above, an auxiliary vacuum system and/or a purge system may be useful to manage the fume level in the printing chamber in general and in the vicinity of the nozzle plate in particular. Consistent with embodiments of the present disclosure, another way to manage the fume level in the vicinity of the printing area is by providing a cold plate such as the cooled shield 116 on which fumes can condensate. Therefore, different characteristics of shield 116 may be considered to determine an amount and rate of fumes that may be condensed on it. The different characteristics of shield 116 may include the size of shield 116 and its heat capacitance. In one embodiment, controller 120 may determine the required amount of cooling needed for shield 116 to avoid dripping on printed object 700 and in order to keep the humidity level within the printing chamber in a required operating range of humidity. According to some embodiments, a humidity sensor communicating with controller 120 may be used to monitor the humidity level around printing region 102 to control the operation of the cooling system.

In addition, a liquid removing element 704 may be configured to remove the condensed vapors from the condensation surface. According to one embodiment, liquid removing element 704 may be a wiper configured to wipe the condensation surface at a predefined cycle. According to another embodiment, a sensor or a camera may image the condensation surface and convey the information to controller 120, which controls the wiper. The wiper may be an integral part of the shield 116 or, alternatively, may not be part of the shield 116 and be placed anywhere along print head 106 and be configured to wipe the condensation surface when print head 106 reaches a certain area. Liquid removing element 704 may be configured to wipe the condensed fumes into a drain port (not shown). Such a drain port may have a fluid communication with the auxiliary vacuum system or alternatively may be a drain port that drains fluid by gravity. The drain port is configured to drain excess liquid to a storage container to collect all the excess liquid. Liquid removing element 704 may be configured to absorb at least part of the condensed liquid from the condensation surface.

Consistent with this aspect of the disclosure, an additive manufacturing apparatus (e.g., additive manufacturing apparatus 100) is provided. The additive manufacturing apparatus may include: a printing tray (e.g., printing region 102) for supporting a three-dimensional object (e.g., object 700) to be constructed layer-by-layer in an additive manufacturing process; a print head holder (e.g., print head holder 104) for maintaining a print head (e.g., print head 106) spaced from the printing tray, wherein the print head includes a plurality of nozzles configured to dispense a composition of a carrier liquid and object particles; a condensation surface (e.g., shield 116) disposed between the printing tray and the print head and being temperature-controlled such that fumes of carrier liquid that evaporate during the additive manufacturing process can condense thereon; and at least one condensation port associated with the condensation surface and configured to collect condensation therefrom. In one example, the additive manufacturing apparatus may include a sensor configured to provide measurements indicative of a temperature of the condensation surface. The sensor may be configured to measure the temperature of the condensation surface. The additive manufacturing apparatus may include a processor (e.g., controller 120) configured to control the temperature of the condensation surface to maintain a fume level at or below a threshold level. The threshold level is chosen to prevent condensed fumes from dripping on the three-dimensional object. In another example, the condensation surface may include at least one channel for directing coolant liquid therethrough, and the sensor is configured to measure a temperature of the coolant liquid as it leaves the condensation surface.

In one embodiment, the additive manufacturing apparatus may include a vacuum source associated with the condensation surface for removing condensation from the condensation surface. In this embodiment, controller 120 may control the vacuum source in order to maintain a predetermined fume level. In another embodiment, the additive manufacturing apparatus may include at least one conduit for connecting the at least one channel to a coolant reservoir and a pump for circulating the coolant liquid from the coolant reservoir through the at least one channel in order to cool the condensation surface. In this embodiment, controller 120 may be configured to change a flow of the coolant liquid in the at least one channel to control the temperature of the condensation surface. In another embodiment, the additive manufacturing apparatus may include a wiper for assisting in removal of condensation from the condensation surface. The wiper may be configured to absorb at least part of the condensed liquid from the condensation surface. Additionally, the wiper may be configured to wipe the condensation surface in predefined cycles. In this embodiment, controller 120 may be configured to determine when to remove the condensed fumes from the condensation surface using information derived from image data of the condensation surface.

It will be apparent to those skilled in the art that various modifications and variations can be made to the disclosed additive manufacturing apparatus, without departing from the scope of the disclosure. Alternative implementations will be apparent to those skilled in the art from consideration of the specification and practice disclosed herein. It is intended that the specification and examples be considered as exemplary only.

What is claimed is:

1. An additive manufacturing apparatus, comprising:
a reservoir configured to contain additive manufacturing material;
a supply conduit for interconnecting the reservoir with a print head for supplying the additive manufacturing material to the print head, wherein the print head has a plurality of nozzles for expelling the additive manufacturing material;
a regulator configured to control pressure of additive manufacturing material in the print head to trigger purging of the print head during a maintenance period;
an air-ink separator configured to receive a mixture of air and purged additive manufacturing material, wherein the air-ink separator is configured to reclaim at least a portion of the additive manufacturing material from the mixture; and
a return conduit interconnecting the air-ink separator with the reservoir for circulating back the reclaimed additive manufacturing material to the reservoir to enable the reclaimed additive manufacturing material to be utilized for manufacturing a three-dimensional object.

2. The additive manufacturing apparatus of claim 1 further comprising:
a printing tray configured to be heated during a printing period; and
a heat shield located between the printing tray and the print head such that an air gap is located between the print head and heat shield, the heat shield is configured to prevent heat from the heated printing tray from overheating the print head and including at least one jetting slit to facilitate printing from the plurality of nozzles atop the heated printing tray during the printing period.

3. The additive manufacturing apparatus of claim 2, wherein the air-ink separator is flow-connected to the air gap between the print head and the heat shield and the air-ink separator is configured to receive the mixture of air and purged additive manufacturing material during the maintenance period.

4. The additive manufacturing apparatus of claim 3, wherein during purging of the print head the regulator increases the pressure of additive manufacturing material in the print head while the pressure in the air-ink separator is decreased.

5. The additive manufacturing apparatus of claim 1, wherein the air-ink separator is configured to reduce the velocity of the mixture of air and additive manufacturing material, thereby encouraging ink droplets in the mixture to sink down due to gravitation force.

6. The additive manufacturing apparatus of claim 5, wherein the air-ink separator includes a funnel-shaped pipe oriented to direct the mixture of air and additive manufacturing material from one side of the air-ink separator toward an opposing side of the air-ink separator.

7. The additive manufacturing apparatus of claim 6, wherein an upper surface of the funnel-shaped pipe ends closer to a wall of the air-ink separator than a lower surface of the funnel-shaped pipe, to encourage ink droplets to flow toward down toward a first zone for collecting additive manufacturing material and not toward a second zone for collecting air.

8. The additive manufacturing apparatus of claim 7, wherein the air-ink separator further comprises an air outlet located in the second zone for evacuating air.

9. The additive manufacturing apparatus of claim 8, wherein the air-ink separator further comprises a filter in the second zone, the filter configured to impede droplets from reaching the air outlet.

10. A maintenance method for an additive manufacturing apparatus, comprising:
supplying additive manufacturing material from a reservoir to a print head, wherein the print head has a plurality of nozzles for expelling the additive manufacturing material;
controlling pressure of additive manufacturing material in the print head to trigger purging of the print head during a maintenance period;
receiving in an air-ink separator a mixture of air and purged additive manufacturing material, wherein the air-ink separator is configured to reclaim at least a portion of the additive manufacturing material from the mixture;
circulating back the reclaimed additive manufacturing material to the reservoir during the maintenance period to enable the reclaimed additive manufacturing material to be utilized for manufacturing a three-dimensional object.

11. The maintenance method of claim 10, further comprising conveying additive manufacturing material collected in the air-ink separator to the print head for manufacturing the three-dimensional object.

12. The maintenance method of claim 10, wherein during a printing period a first pressure is applied in the air-ink separator and during the maintenance period a second pressure in applied in the air-ink separator.

13. The maintenance method of claim 12, wherein the second pressure is a negative pressure.

14. The maintenance method of claim 13, wherein the negative pressure is configured to suck the mixture of air and additive manufacturing material from a gap between the print head and an heat shield.

15. The maintenance method of claim 14, wherein during the printing period the printing tray is heated from a side opposite the print head.
